(19) United States
(12) Patent Application Publication
(10) Pub. No.: US 2017/0076230 A1
(43) Pub. Date: Mar. 16, 2017

(54) Business method to generate income for a free internet browser provider or developer

(71) Applicant: Christian Roland Blank, Moosinning (DE)

(72) Inventor: Christian Roland Blank, Moosinning (DE)

(21) Appl. No.: 14/850,263

(22) Filed: Sep. 10, 2015

(51) Int. Cl. G06Q 10/06; H04L 29/08

(52) U.S. Cl. CPC G06Q 10/067; H04L 67/02

(57) ABSTRACT

The presented business method focuses on generating income as an internet browser provider or developer by restricting the access to cookies to paying customers.

The usage, reading and/or writing, of cookies on the data medium of a user's device is to be controlled by the internet browser of the provider or developer and/or generally not supported by this internet browser. Every web page on the internet which wants to be able to use, reading and/or writing, cookies with the internet browser of the provider or developer will have to pay a fee to do so.

An internet browser provider or developer who markets his software for free, codes his internet browser software in such a way that it automatically restricts the usage of cookies on any websites not distributed by an authorized third party entity. He grants the usage of cookies—such as reading, writing or either—for websites supplied by authorized third parties and offers third parties the option to become an authorized third party by paying a fee.

### CROSS-REFERENCE TO RELATED APPLICATIONS

This application claims the benefit of provisional patent application Ser. No. 62/071,073, filed 2014 Sep. 15 by the present inventor.

### FEDERALLY SPONSORED RESEARCH

none

### SEQUENCE LISTING

none

### BACKGROUND

Prior Art

No similar business ideas are known to the inventor.

Background

If an internet user wants to access a web page, he needs a computer, laptop, tablet or cell phone with a data medium and a display or screen, an internet access and an installed internet browser. In order to correctly display the web page, the server, this is the place where the web page is hosted, is instructed to copy the entire HTML content and other data of the web page to the data medium of the device which is used to access the page. The used internet browser transforms this saved data in a graphical display of the requested web page on the screen of the used machine.

A web page is also able to write so called cookies to the data medium of the device of the internet user. Those cookies allow the web page to store and load user specific data directly on the accessing device. The lifetime of the cookie can be freely chosen by the web page programmers. It can expire within the next page refresh or stay with the browser for its entire lifetime.

Today, almost every internet browser is free to use. Those programs are also continually improved and supported by the manufacturer. However, with the application being freely available, the provider of the software can earn no money and make no profit with his service. On the other hand, companies are making a lot of money by using reading and writing cookies on the user's device. Some internet companies save user specific data, like terms used in a search engine, in the form of cookies on device of the user. Other web pages can read this data in order to provide the user with personalized advertisements. For example if the user searched for a specific car, another web page would be able to read this information and display an advertisement for the car the user has searched for.

Many internet shops use cookies to store the contents of a user's shopping cart. In this case, placing an order would not be possible without the use of cookies. Advertisement based web pages are able to generate a selective advertisement by reading information out of the cookies. Many companies earn money in the internet by using, reading and/or writing, cookies. They are also enabled to realize personal actions, such as internet shops, personalized address forms or social networks.

In doing so, every use of cookies is completely free for the company operating a web page. The lifetime of the cookies which get saved on the data medium of the user's device is absolutely arbitrary, a programmer may set the timespan according to his needs. Ultimately, they are able to read out all cookies stored on the user's device.

The presented business method is based on the assumption that an internet browser provider or developer raises a fee for using, reading and/or writing, cookies, so that any service based on the use of cookies will need to pay a certain amount of money for using the cookies on a specific web browser.

The advantage of this method is the generation of income for the browser provider or developer, where until now no money could be earned by programming and allowing free download and usage of an internet browser.

### SUMMARY

An internet browser developer can define the lifetime of cookies or the permission to readout available cookies and restrict the usage of cookies to authorized third party entities, such as web pages and selective advertisements from other companies. In order to authorize cookie usage on the browser, third party entities will have to pay a fee to the browser developer.

### ADVANTAGE

The idea is to generate income for the internet browser provider or developer, where until now there was no money to be earned by supplying the browser to the user free of charge.

### DRAWINGS—FIGURES

There are no drawings included.

### DETAILED DESCRIPTION

The presented business method focuses on generating income as an internet browser provider or developer by restricting access to cookies to paying customers.

An internet user who wants to access a web page needs a device as a computer, laptop, tablet or a cell phone with a data medium and a display or screen, an internet access and an installed internet browser.

The usage, reading and/or writing, of cookies on the data medium of a user's device is to be controlled by the net browser of the provider or developer and/or generally not supported by this internet browser. Every web page on the internet which wants to be able to use, reading and/or writing, cookies with the internet browser of the provider or developer will have to pay a fee to do so. The guidelines for cookie monetization can be as strict as no cookie usage at all.

### Operation

The internet browser provider or developer will have to code the application in such a way so that it's able to distinguish between browsing a web page of a paying customer and visiting another arbitrary site, in which case the cookies will not work.

The web pages of paying customers are registered and allowed to use, reading and/or writing, cookies from the data medium of the internet user's device. All other web pages are not able to use, reading and/or writing, cookies on the data medium of the user's device.

The lifetime of the cookies on the data medium of the internet user's device is controlled by the browser. It will delete cookies if necessary or their lifetime has expired. It will block the usage, reading and/or writing, of cookies on unregistered web sites. If a web page is registered at the internet browser provider or developer, then the browser allows the web page to use, reading and/or writing, cookies on the data medium of the internet user's device.

### Alternative Embodiments

The internet browser provider or developer does not code his program in a way that reading and/or writing of cookies is restricted. Instead, he claims that the third parties, such as web site owners or advertisement companies, must pay a fee even for not-restricting the usage of cookies.

### Advantages

From the description above, a number of advantages of this business method become evident:

(a) It generates income for the internet browser provider or developer, where until now there was no money to be earned by supplying the browser to the user free of charge. (b) Only cookies of websites supplied by authorized third party entities need to be saved on the users' device.

(c) The net browser provider or developer is able to protect the user against tracking cookies or cookies used for malicious attacks.

(d) The net browser provider or developer can disable personalized advertisement for the user.

### CONCLUSION

The advantages of the proposed business method suggest a safer and faster internet surfing experience by restricting the usage of cookies. The internet browser provider or developer is able to increase privacy protection of the user by restricting tracking cookies and general internet safety by not accepting unauthorized cookies, such as cookies used for malware. In the end, the internet browser provider or developer is able to generate income directly from the usage of his product, the internet browser, even though the availability for the internet user is free of charge.

I claim:

1. A method of generating income for an internet browser provider or developer who markets his software for free, comprising:
a. coding the internet browser software in such a way that it automatically restricts the usage of cookies on any websites not distributed by an authorized third party entity,
b. granting the usage of cookies—such as reading, writing or either—for websites supplied by authorized third parties
c. offering third parties the option to become an authorized third party by paying a fee

2. The method of claim 1 wherein the code of the internet browser program is not changed as said in claim 1a, but just for this not restricting the useage of cookies in general the web site owners or other companies pay a fee therefor, in detail for the not-restricting.
